(19) United States
(12) Patent Application Publication
(10) Pub. No.: US 2011/0231306 A1
(43) Pub. Date: Sep. 22, 2011

(54) Remotely controlled system and method for the preparation of a user-defined food product or beverage

(76) Inventor: Peter S. Stutman, Sudbury, MA (US)

(21) Appl. No.: 13/068,763

(22) Filed: May 19, 2011

Related U.S. Application Data
(63) Continuation of application No. 12/011,429, filed on Jan. 25, 2008, now abandoned.
(60) Provisional application No. 60/897,454, filed on Jan. 25, 2007.

(51) Int. Cl. G06Q 40/00; G06F 19/00; G06F 17/00

(52) U.S. Cl. 705/39; 700/103; 705/400

(57) ABSTRACT

A remotely controlled system for the preparation of a user-defined food product or beverage including an input module on a remote device configured to input user-specified parameters associated with the preparation of the user-defined food product or beverage. A user profile module on one or more servers is configured to store one or more of the user-specified parameters, predetermined alerts, and nutritional information associated with the user-specified parameters and send one or more of the user-specified parameters, predetermined alerts and nutritional information for display on the input module. A local controlling computer subsystem is responsive to the input module controlling computer subsystem and is configured to prepare the user-defined food product or beverage based on the one or more commands and interactive instructions from the user.

### RELATED APPLICATIONS

This application is a continuation of and claims priority to prior U.S. patent application Ser. No. 12/011,429, filed Jan. 25, 2008 under 35 U.S.C. §§119, 120, 363, 365, and 37 C.F.R. §1.55 and §1.78, which claims the benefit of and priority to U.S. Provisional Application No. 60/897,454, filed Jan. 25, 2007, entitled “Remotely controlled and robotic system and method for the preparation of food and beverages”, both applications are incorporated by reference herein.

### FIELD OF THE INVENTION

This invention relates to a remotely controlled system and method for the preparation of a user-defined food product or beverage.

### BACKGROUND OF THE INVENTION

Conventional automated systems and processes for the preparation of food products are known. For example, U.S. Pat. No. 5,997,924 to Olander, Jr. et al. discloses a fully automated system for the ordering, purchasing, and cooking of pizzas which requires the user to be in close proximity to a self-contained system. U.S. Pat. No. 7,174,830 to Dong discloses a robotic cooking system wherein a predetermined list of ingredients are directly selected by a user or entered via a controlling computer.

However, the aforementioned systems and processes do not provide nutritional information associated with the user-defined food product. Such systems and process also cannot accept user-specified parameters associated with the preparation of a user-defined food product from a remote location. The systems and processes are also are unable to accept user provided lists of ingredients, recipes, or ingredients the user may be allergic to. Thus, these systems and processes cannot alert the user when the selected food product may exceed user provided nutritional limits or include an ingredient the user in allergic to. These systems and processes are typically not connected to a network and thus cannot accept user provided parameters for the preparation of a food product from a remote location. Moreover, once the user has made selections and the automated process has begun to prepare the food product, deviations or changes from those selections are not possible. For example, such systems and methods cannot accommodate a request such as “cook the pizza a little more”. These systems and process also do not allow the user to directly participate in the preparation and cooking process or directly control the sequence of food preparation operations. Such conventional food preparation systems do not teach or disclose that the automated food preparation system or process may include a human food or beverage preparer. The spatial distribution and geometric pattern of distribution of ingredients is limited to pre-programmed selections. Although the system and process of the '924 patent can provide a virtual representation of the pizza before or after it is cooked, the system does not provide a visual representation of what the pizza looks like while it is cooking.

### BRIEF SUMMARY OF THE INVENTION

It is therefore an object of this invention to provide a remotely controlled system and method for the preparation of a user-defined food product or beverage.

It is a further object of this invention to provide such a system and method which provides nutritional information associated with one or more ingredients of a user-defined food product.

It is a further object of this invention to provide such a system and method which simultaneously accepts user-specified parameters associated with the preparation of a user-defined food product or beverage from one or more users at one or more remote locations.

It is a further object of this invention to provide such a system and method which accepts a user provided list of ingredients to prepare a user-defined food product.

It is a further object of this invention to provide such a system and method which accepts a user provided recipe to prepare a user-defined food product.

It is a further object of this invention to provide such a system and method which accepts and tracks user provided nutritional limits.

It is a further object of this invention to provide such a system and method which accepts and tracks one or more ingredients the user may be allergic to.

It is a further object of this invention to provide such a system and method which alerts the user that a user provided nutritional limit may be exceeded.

It is a further object of this invention to provide such a system and method which alerts the user that a user-defined food product or beverage may include an ingredient to which the user is allergic.

It is a further object of this invention to provide such a system and method in which the user can remotely control how a user-defined food product or beverage is prepared.

It is a further object of this invention to provide such a system and method in which the user can remotely interact with a human food or beverage preparer so as to specify how the user-defined food product or beverage should be prepared.

It is a further object of this invention to provide such a system and method which allows the user to control the spatial distribution and geometric pattern of distribution of one or more ingredients.

It is a further object of this invention to provide such a system and method which provides a visual representation of how a user-defined food product or beverage will look like before, during, and after it is prepared.

This invention features a remotely controlled system for the preparation of a user-defined food product or beverage including an input module on a remote device configured to input user-specified parameters associated with the preparation of the user-defined food product or beverage. A user profile module on one or more servers is configured to store one or more of the user-specified parameters, predetermined alerts, and nutritional information associated with the user-specified parameters and send one or more of the user-specified parameters, predetermined alerts and nutritional information for display on the input module. A local controlling computer subsystem is responsive to the input module on the remote device and translates the user-specified parameters from the input module into one or more commands. An automated food preparation subsystem is responsive to the local controlling compute subsystem and is configured to prepare the user-defined food product or beverage based on the one or more commands and interactive instructions from the user.

In one embodiment, the user-specified parameters may include a parameter chosen from the group consisting of: ingredient identity, ingredient amount, ingredient spatial distribution, ingredient geometric pattern, cooking temperature, cooking time, physical translation of a cooking device, a sequence of combinations of ingredients, a sequence of cooking operation instructions, a sequence of preparation and cooking operations, instructions to a food or beverage preparer, a user-provided list of ingredients, and a user-provided recipe. The input module may display a graphical user interface provided by the one or more servers. The remote device may be a device chosen from the group consisting of: a client computer, a personal digital assistant (PDA), a human input device (HID), a personal communicator, a wireless telephone, and an internet tablet. The remote device may be connected to the one or more servers by a communication channel chosen from the group consisting of: the internet, a wide area network (WAN), a local area network (LAN), and a wireless communications channel. The one or more servers may be connected to the local controlling subsystem by a communication channel chosen from the group consisting of: the internet, a wide area network (WAN), a local area network (LAN), a wireless communications channel, and a direct connection. The local controlling computer may be connected to the automated food preparation subsystem by a communication channel chosen from the group consisting of: the internet, a wide area network (WAN), a local area network (LAN), a wireless communications channel, and a direct connection. The automated food preparation system may include one or more food processors. The input module may be configured to interactively compute the cost related to the preparation of the user-defined food product or beverage. The system may further include a networked payment subsystem configured to receive payment for the user-defined food product or beverage. The automated food preparation subsystem may include a video device for providing a visual representation of the user-defined food product or beverage before, during, and/or after the user-defined food product or beverage is prepared. The graphical interface may display the appearance of the user-defined food product or beverage before, during and after the food product is prepared on the input module. The user profile module may be configured to retrieve nutritional information associated with each user-selected ingredient and/or each user-selected ingredient amount and/or each user-specified list of ingredient and/or each user-provided recipe from the one or more servers. The one or more servers may include one or more servers chosen from the group consisting of: a remote server, a local server, and a combination of one or more remote servers and one or more local servers. The input module may store one or more user-specified templates. The one or more user-specified templates may define the ingredient spatial distribution and the ingredient geometric pattern of the user-defined product. The predetermined alerts may include an alert chosen from the group consisting of: an alert indicating a user provided nutritional limit may be exceeded, an alert indicating an undesirable user-defined food product or beverage will be prepared, an alert indicating an injurious user-defined food product or beverage will be prepared, and an alert indicating a physically impractical user-defined food product or beverage will be prepared. The alert indicating an injurious user-defined food product or beverage that will be prepared may include an indication the user is allergic to at least one ingredient in the user-defined food product or beverage. The user-specified parameters may be input by one or more users at one or more remote locations. The user may remotely control the user-specified parameters to be used in the preparation of the user-defined food product or beverage by the automated food preparation subsystem. The automated food preparation subsystem may include a human food beverage or beverage preparer. The user may remotely control the user-specified parameters to be used in the preparation of the user-defined food product by the human food or beverage preparer. The automated food preparation subsystem may be robotic, teleoperated, or robotic and teleoperated. The user-defined food product or beverage may be a food product or beverage chosen from the group consisting of: a pizza, an ice cream sundae, a dessert, a meal eaten at a restaurant, take-out food, and a mixed beverage.

This invention also features a remotely controlled system for the preparation of a user-defined food product or beverage including an input module on a remote device configured to receive user-specified parameters associated with the preparation of the user-defined food product or beverage. A nutritional module is configured to retrieve nutritional information from one or more servers of the user-specified parameters and compute and display the nutritional information to a user. A local controlling computer subsystem is responsive to the input module on the remote device for translating the user-specified parameters from the input module on the remote device into one or more commands. An automated food preparation subsystem is responsive to the local controlling computer subsystem and is configured to prepare the user-defined food product or beverage based on the one or more commands and interactive instructions from the user.

This invention also features a remotely controlled method for the preparation of a user-defined food product or beverage, the method including receiving user-specified parameters associated with the preparation of the user-defined food product or beverage on an input module; storing one or more of the user-specified parameters, predetermined alerts, and nutritional information associated with the user-specified parameters on one or more servers and sending and displaying the user-specified parameters, predetermined alerts and nutritional information for display on the input module; translating the user-specified parameters from the input module into one or more commands; and controlling the preparation of the user-defined food product or beverage based on the one or more commands and interactive instructions from a user.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram of one embodiment of the remotely controlled system for the preparation of a user-defined food product or beverage of this invention;

FIG. 2 is a schematic block diagram of one embodiment of the input module shown in FIG. 1;

FIG. 3 is a schematic block diagram of one embodiment of the user profile module shown in FIG. 1;

FIGS. 4A-4B are schematic diagrams showing one example of the automated food preparation subsystem shown in FIG. 1 configured to prepare user-defined pizza;

FIG. 5 is a schematic diagram showing one example of the automated food preparation subsystem shown in FIG. 1 configured to prepare a user-defined ice cream sundae; and

FIG. 6 is a schematic block diagram showing one embodiment of the primary steps of the remotely controlled method for the preparation of a user-defined food product or beverage of this invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

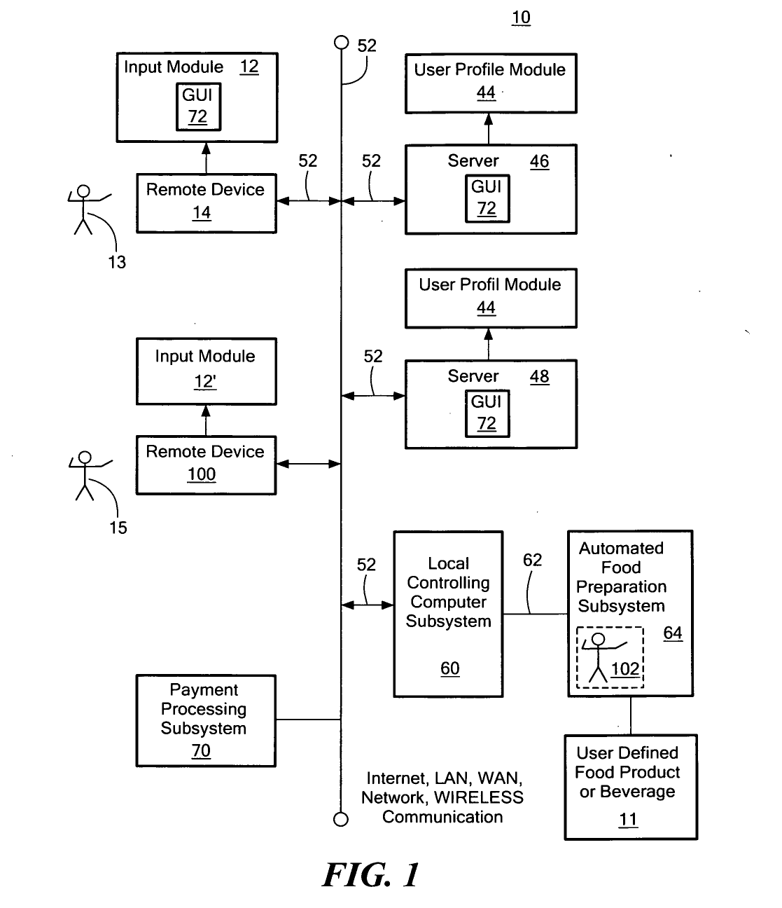

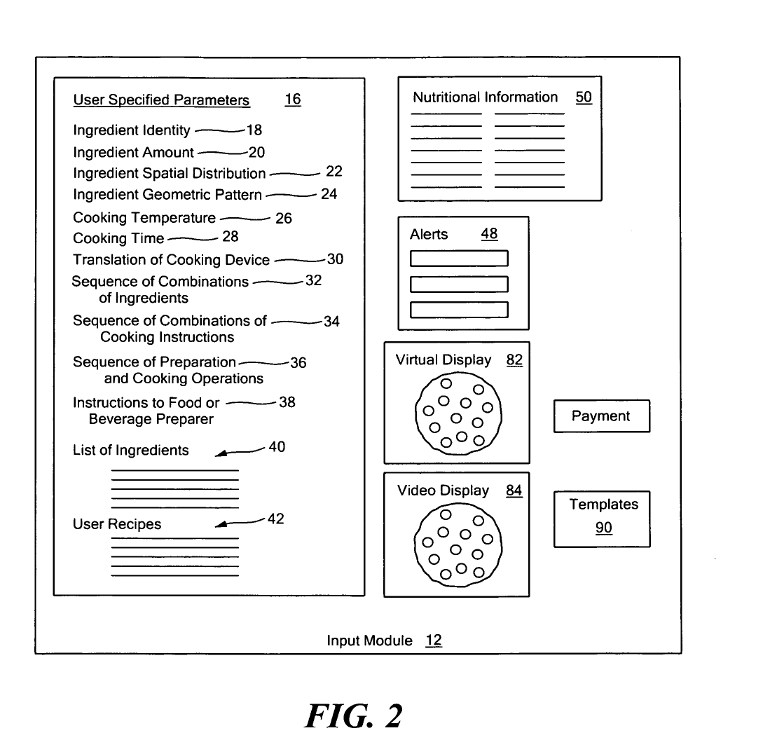

There is shown in FIG. 1, remotely controlled system 10 for the preparation of a user-defined food product or beverage 11, e.g., a pizza, an ice cream sundae, a mixed beverage, a dessert, a meal which is eaten at a restaurant, a meal ordered for take-out food, and the like. System 10 includes input module 12 residing on remote device 14. Remote device 14 may be a client computer, a personal digital assistant (PDA), a human input device (HID), a wireless telephone, a personal communicator, an interne tablet, or any similar type device known by those skilled in the art. Input module 12 is configured to input user-specified parameters 16, FIG. 2, associated with the preparation of user-defined food product or beverage 11, FIG. 1. In one design, input module 12 displays graphical user interface (GUI) 72 which is provided one or more of server 46, 48 via communications channel 52 (discussed below). Input module 14 may capable of multi-media display including graphics, video, audio, text and force feedback, as known by those skilled in the art. User-specified parameters 16, FIG. 2, may include, inter alia, ingredient identity 18, ingredient amount 20, ingredient spatial distribution 22, ingredient geometric pattern 24, cooking temperature 26, cooking time 28, translation of a cooking device 30, sequence of combinations of ingredients 32, sequence of combinations of cooking instructions 34, sequence of preparation and cooking operations 36 (e.g. stirring, shaking, mixing or other cooking operations), instructions to a human food or beverage preparer 38, list of ingredients 40, and one or more of user-provided recipes 42.

In operation, a user, e.g. user 13, FIG. 1, selects one or more of user-specified parameters 16, FIG. 2, displayed on input module 12 on remote device 14, FIG. 1, by using a mouse and keyboard or a touch screen, as known by those skilled in the art. See e.g., U.S. Pat. No. 5,997,924 to Olander, Jr. et al., incorporated by reference herein.

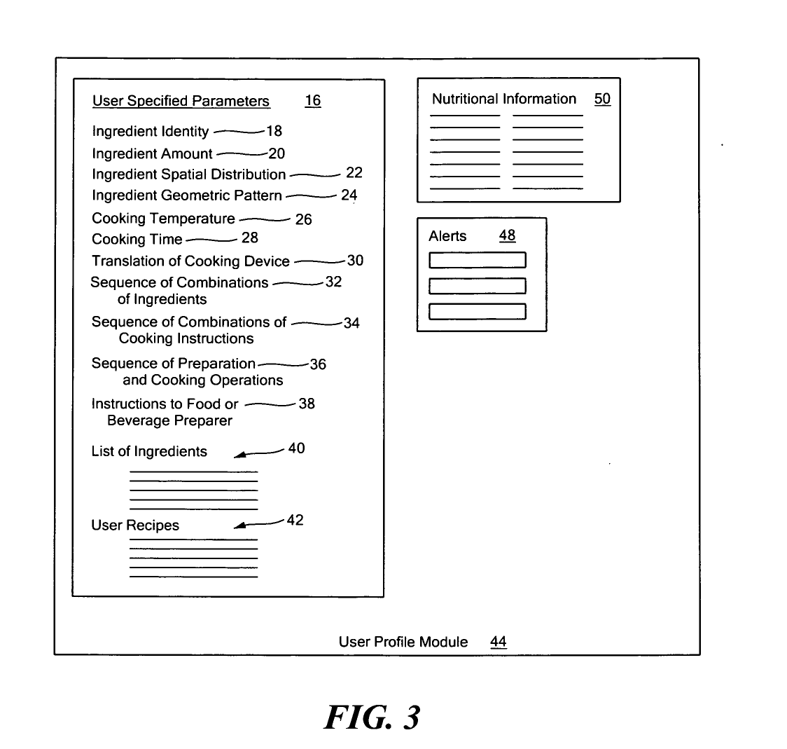

System 10 also includes user profile module 44 on one or more servers 46, 48. User profile module 44, FIG. 3, is configured to store one or more servers 46, 48 various previously selected user-specified parameters 16 selected by user 13 using input module 12 on remote device 14, FIGS. 1 and 2 and/or user 15 using input module 12′ on remote device 100, predetermined alerts 48, FIG. 3 and nutritional information 50 associated with user-specified parameters 16 for the preparation of food product or beverage 11, FIG. 1. User profile module 44 may also store on servers 46, 48 the current various user-specified parameters 16 selected by user 13 and/or user 15 using input module 12′ at a remote location (discussed below). User profile module 44 sends one or more of the user-specified parameters 16, alerts 48, and nutritional information 50 to input module 12 and/or input module 12′ via communications channel 52, e.g., the Internet, a wide area network (WAN), a local area network (LAN), or a wireless communications channel, where they are displayed on input module 12, 12′, FIG. 2. One or more of servers 46, 48 may be a Weight Watchers® server and includes various nutritional information 50 associated with one or more Weight Watchers® programs.

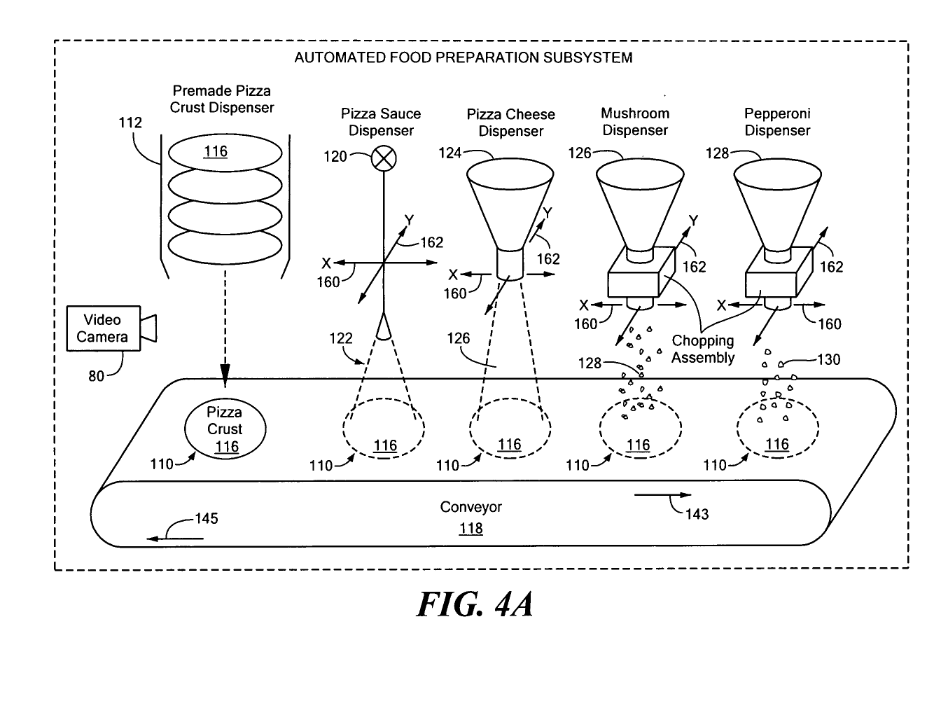

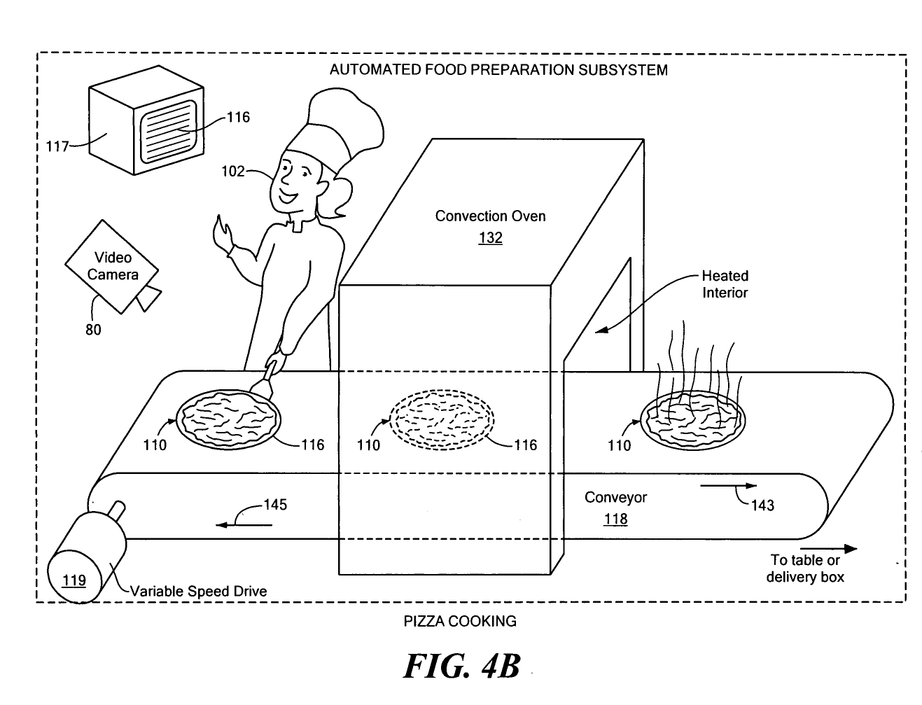

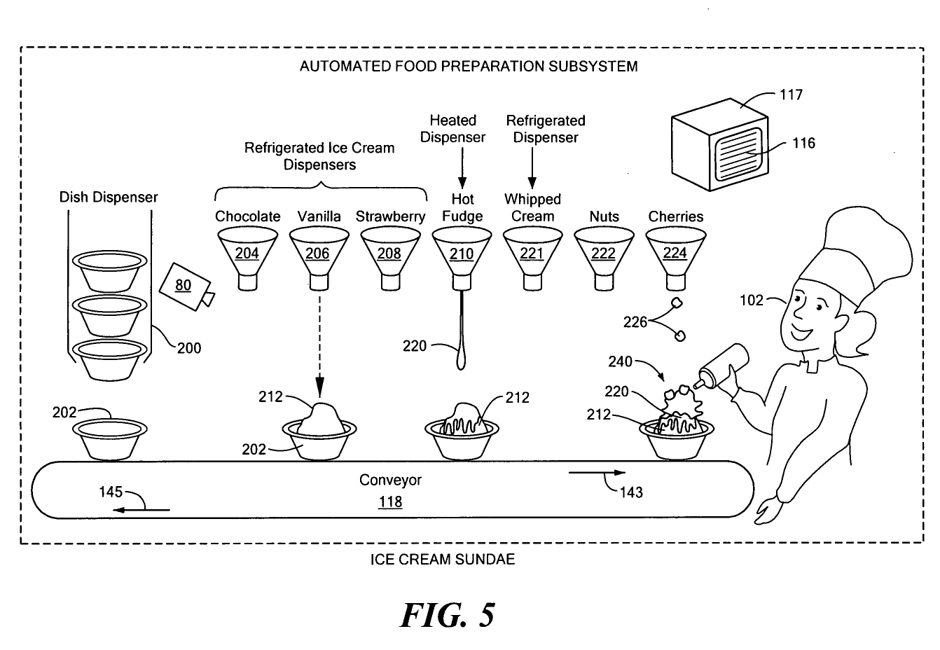

Local controlling computer 60, FIG. 1, is responsive to input module 12, 12′ on remote device 14 by communications channel 52 and translates the user-specified parameters 16, FIG. 2, from input module 12, 12′ into one or more commands which are sent to automated food preparation subsystem 64, e.g., by a communication channel such as a WAN, a LAN, a wireless communications channel, or a direct connection. Automated food preparation subsystem 64 responds to the commands sent by local controlling computer subsystem 60 and interactive instructions from user 13 interacting with input module 12 on remote device 14 and/or user 15 interacting with input module 12′ on remote device 100 to prepare user-defined food product or beverage 11. Automated food preparation subsystem 64 may include various devices for preparing user-defined food product or beverage 11, e.g., a one or more food processors as shown in FIGS. 4A-4B and FIG. 5, or any other type food processor as known by those skilled in the art. Automated food preparation subsystem 64 may be located in restaurant, building, store, or a home. Further details as to the construction and operation of automated food preparation subsystem 64 are disclosed e.g., in U.S. Pat. No. 5,997,924 to Orlando, Jr. et al., cited supra, U.S. Pat. No. 7,174,830 to Dong, and U.S. Patent Application Publication No. 2007/0158335 to Mansbery, all incorporated by reference herein.

User profile module 44, FIGS. 1 and 3 retrieves nutritional information 50, FIG. 3, associated with each user-selected ingredient identity 18 and/or each user-selected ingredient amount 20 and/or each user-specified list of ingredients 40 and/or each user-specified recipe 42 from more servers 46, 48. Servers 46, 48 may be a remote server, a local server, or a combination of one or more remote servers and one or more local servers. Thus, when user 13 and/or user 15 selects one or more user-specified parameters 18, 20, 40, or 42 using input module 12, 12′, FIG. 2, user profile module 44, FIGS. 1 and 3, retrieves the nutritional information associated with the user selected parameters and displays those nutritional parameters as nutritional information 50, FIG. 2 on input module 12. The result is user 13 or user 15 is able to select various user-specified parameters 16 and know the nutritional information associated with the ingredients of the user-specified food product or beverage. The result is user 13 and/or user 15 who may be monitoring caloric intake can easily find the nutritional information associated with the selected ingredient identity 18, ingredient amount 20, list of ingredients 40, or user recipes 42. In one example, a dietitian may monitor nutritional information 50 associated with the user selected ingredient identity 18, ingredient amount 20, list of ingredients 40, or user recipe 42 and inform the user that user-defined food product 11 should not be prepared or eaten, unless appropriate changes are made to one or more of the list of ingredients, the amount of one or more ingredients, the recipe, the user specified sequence of cooking operations and the user specified list of cooking and preparation parameters.

User profile module 44, FIGS. 1 and 3 also stores on one or more of servers 46, 48 alerts 48, FIG. 3 and sends alerts 48 to input module 12, 12′, FIG. 2 via communications channel 52, FIG. 1. Alerts 48, FIG. 2 may indicate to user 13 and/or user 15 that a user-provided nutritional limit may be exceeded if user-defined food product 11, FIG. 1, is prepared according the user-specified parameters 16, FIG. 2. Alerts 48 may also indicate that an undesirable food product or beverage 11, FIG. 1, will be prepared by automated food preparation subsystem 64, an injurious user-defined food product or beverage 11 will be prepared by automated food preparation subsystem 64, or a physically impractical user-defined food product or beverage 11 will be prepared will be prepared by automated food preparation subsystem 64. In one example, alerts 48 may indicate the injurious user-defined food product or beverage 11 that will be prepared may include at least one ingredient the user is allergic to. Thus, not only can system 10 provide the user with nutritional information associated with user-defined food product or beverage 11, system 10 can alert the user to ingredients the user is allergic to and thus prevent preparation of an injurious food product.

In one example, input module 12, FIG. 2, includes graphical interface 84, e.g., a video interface, which provides a virtual display of how user-defined food product or beverage 11, FIG. 1 will look before it is prepared. System 10 may also include video device 80, e.g., a video camera, FIGS. 4A-4B and 5 that is used to display on graphical interface 84, FIG. 2, the appearance of user-defined food product 11, e.g., pizza 110, FIG. 4A, or ice cream sundae 240, FIG. 5, during preparation and after the food product is prepared.

In one example, input module 12, FIG. 2, can store one or more user-specified templates 90 which define the ingredient spatial distribution 22 and ingredient geometric pattern 24 or user selected ingredients on user-defined food product 11, FIG. 1 (discussed in further detail below).

User-specified parameters 16, FIG. 2 may be collaboratively input by one or more users at one or more remote locations. For example, user-specified parameters 16 may be input by user 13, FIG. 1 using input module 12 on remote device 14 in one location and by user 15 using input module 12′ on remote device 100 at a different location. Such a design allows users 13 and 15 located at completely different locations, e.g., in Japan and in the United States, to collaboratively input user-specified parameters 16 for the preparation of user-defined food product or beverage 11 which is prepared by automated food preparation subsystem 64.

Input module 12 on remote device 14 can preferably be used by a user 13 and/or user 15 to remotely control various user-specified parameters 16, FIG. 2, e.g., any of parameters 18-38, to be used in the preparation of user-defined food product or beverage 11, FIG. 1 by automated food preparation subsystem 64. In one example, user 13 and/or user 15 can remotely control any of user-specified parameters 18-38, FIG. 2, to be used in the preparation of user-defined food product or beverage 11, FIG. 1, that may include instructions to human or beverage preparer 102, e.g., instructions to a cook, chef, or bartender that works in concert with automated food preparation subsystem 64 (discussed in further detail below).

In one embodiment, automated food preparation subsystem 64, FIG. 1 may be robotic. In other embodiments, automated food preparation subsystem 64 may be teleoperated. In yet another embodiment, automated food preparation subsystem 64 may be a combination of robotic and teleoperated.

Input module 12, FIGS. 1 and 2, may be configured to interactively compute the cost related to the preparation of user-defined food product or beverage 11. Input module 12 tracks the cost associated with each ingredient identity 18 and each ingredient amount 20 selected by the user. Network payment subsystem 70 then processes the payment, e.g., by accepting a credit card, debit card ATM card, or cash. See e.g., U.S. Pat. No. 5,997,924 cited supra.

One exemplary embodiment of automated food preparation subsystem 64 is shown in FIGS. 4A-4B. In this example, automated food preparation subsystem 64 is configured to prepare pizza 110. In this embodiment, food preparation subsystem 64 includes video camera 80, discussed above, that displays a visual representation of pizza 110 on display 84, FIG. 2, during and after pizza 110 is prepared. In this example, automated food preparation subsystem 64 includes pizza crust dispenser 112 which dispenses pre-made pizza crust 116 onto conveyer belt 118. Conveyer belt 118 then moves pizza crust 116 in direction 143 proximate to pizza sauce dispenser 120. Pizza sauce dispenser 120, which translates in directions 160 and 162, dispenses a user-specified amount of pizza sauce 122 on pizza crust 116 using one or more commands from local controlling computer subsystem 60, FIG. 1 and input module 12, as discussed above. Conveyer 118, FIG. 4A then moves pizza crust 116, now having pizza sauce 122 thereon proximate to pizza cheese dispenser 124. Pizza cheese dispenser 124, similarly translates in directions 160 and 162 to dispense a user-specified amount of cheese 128 onto pizza crust 116 and pizza sauce 122. Pizza crust 116 with pizza sauce 122 and pizza cheese 126 then moves proximate to mushroom dispenser 126 which chops and dispenses a user specified amount of mushrooms 128 onto pizza crust 116 by translating in directions 160, 162. Conveyer belt 118 then moves pizza 110 proximate to pepperoni dispenser 128 which similarly translates directions 160, 162 to dispense a user-specified amount of pepperoni 130 onto pizza crust 116. In one example, user 13 and/or user 15 can use input module, 12, 12′, FIG. 2, to specify and user-defined ingredient spatial distribution 22, ingredient geometric pattern 24, and/or template 80 to control pepperoni dispenser to dispense pepperoni 130 in any user-defined spatial distribution or geometric pattern. Conveyer 118, FIG. 4B, then moves pizza 110 towards convection oven 132. In one embodiment, human preparer 102 may receive user-specified parameters 16 from input module 12, 12′, FIGS. 1 and 2, which are displayed as instructions 116 on monitor 117, e.g., make pizza crust 116 a little flatter, or add some more pepperoni. For example, user 13 and/or user 15, may, after looking at pizza 110 on graphical interface 84, FIG. 2, provided by video camera 80, FIG. 4B, may decide pizza 110 needs more pepperoni. To accommodate this request, user 13 and/or user 15 selects ingredient identity 18 and ingredient amount 20, FIG. 2 on input module 12. Automated food preparation subsystem 64, FIG. 4B then moves pizza 110 on conveyer belt 118 in direction 145 using drive 119 such that pizza 110 is proximate pepperoni dispenser 128, FIG. 4A. Pepperoni dispenser 128 then dispenses the user selected amount of pepperoni that was chosen by ingredient identity 18 and ingredient amount 20 on input module 12, 12′. Thus, automated food preparation subsystem 64 may be operated in a robotic and/or a teleoperated mode. As pizza 110, FIG. 4B, moves towards convection oven 132, user 13 and/or user 15 can control how pizza 110 will be cooked by controlling the temperature of oven 132 by using cooking temperature parameter 26, FIG. 2, and/or by controlling the time pizza 110, FIG. 4B will be in oven 132 by using the cooking time parameter 28, FIG. 2, which controls the speed of conveyer belt 118, FIG. 4B with variable speed drive 119. The final user-defined product, pizza 110, which has been cooked to any of various user-specified parameters 16 then exits convection oven 132 and is delivered to user 13 or user 15, e.g., at a restaurant, a store, a building, delivered to the home of the user, or picked up by the user. The user-defined food product, e.g., pizza 110 may be frozen or sealed in a retort pouch. Input module 12, FIGS. 1 and 2 tracks the cost associated with each ingredient and each ingredient amount selected by the user. Networked payment processing subsystem 70, FIG. 1 accepts payment from the user, as discussed above.

Another exemplary operation of automated food preparation 64 is shown in FIG. 5 where like parts have been given like numbers. In this example, automated food preparation subsystem 64 is used to prepare an ice cream sundae. In this example, dish dispenser 200 dispenses dish 202 onto conveyer belt 118. Dish 202 moves on conveyer belt in direction 143 proximate to chocolate ice cream dispenser 204, vanilla ice cream dispenser 206, and strawberry ice cream dispenser 208. Based on the combination of ingredient identity 18, FIG. 2 and/or ingredient amount 20 provided by the user 13 and/or user 15 using input module, 12, 12′, the user-desired ice cream flavor is dispensed by one or more of ice cream dispensers 204-208 into dish 202, e.g., in this example, vanilla ice cream 212 is dispensed by vanilla ice cream dispenser 206 into dish 202. Dish 202 is then moved proximate heated dispenser 210, e.g., hot fudge dispenser, using conveyer belt 118. Hot fudge dispenser dispenses a user-specified amount of hot fudge 220 on top of ice cream 212 in dish 202. Dish 202 with ice cream 212 and hot fudge 22 is then moved proximate whip cream dispenser 220, nut dispenser 222 and cherry dispenser 224. Based on user selected ingredient identity 18, FIG. 2 and/or ingredient amount 20 provided by user 13 and/or user 15 using input module 12, 12′, dispensers 220-224 dispense the appropriate amount of whipped cream and/or nuts and/or cherries. In this example, the user 13 has selected cherries 226 be dispensed. Similar as discussed above with reference to FIGS. 4A-4B, user 13 and/or user 15 can interactively provide various user-specified parameters 16 to automated food preparation subsystem 64, e.g., “add more whipped cream”, In this example, automated food preparation subsystem 64 can either move dish 202 on conveyer belt 118 in direction 145 proximate to whipped cream dispenser 22 to perform the operation, or human preparer 102 can perform the operation based in instructions 116 on monitor 118 provided by user 13 and/or user 15. The final user-defined ice cream sundae 240 exits conveyer belt 118 and is provided to the user, e.g., as discussed above with reference to FIG. 4B. Input module 12, FIG. 1 tracks the cost associated with each ingredient and each ingredient amount selected by the user. Payment processing subsystem accepts payment from the user.

Although as discussed above with reference to FIGS. 4A-5, automated food preparation subsystem 64 is used to prepare a user-defined food product or beverage 11 that includes a pizza or an ice cream sundae, this is not a necessary limitation of this invention.

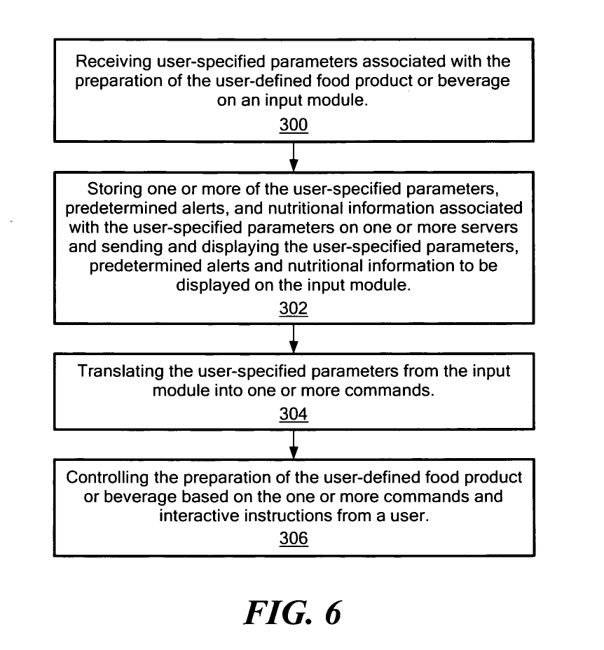

One embodiment of the remotely controlled method for the preparation of a user-defined food product or beverage includes receiving user-specified parameters associated with the preparation of the user-defined food product or beverage on an input module, step 300, FIG. 6; storing one or more of the user-specified parameters, predetermined alerts, and nutritional information associated with the user-specified parameters on one or more servers and sending and displaying the user-specified parameters, predetermined alerts and nutritional information to be displayed on the input module, step 302; translating the user-specified parameters from the input module into one or more commands, step 304; and controlling the preparation of the user-defined food product or beverage based on the one or more commands and interactive instructions from a user, step 306.

The result is system 10 of this invention provides nutritional information associated with one or more ingredients of a user-defined food product. System 10 also accepts user-specified parameters associated with the preparation of a user-defined food product or beverage from one or more remote locations. System 10 accepts and processes a user provided list of ingredients, or a user provided recipe. System 10 also accepts and tracks a user provided nutritional limits as well as one or more ingredients the user may be allergic to. System 10 can also provide alerts that a user provided nutritional limit may be exceeded or when a user-defined food product or beverage may include an allergic ingredient. System 10 can remotely control the method by which a user-defined food product or beverage is prepared and allows the user to remotely provide instructions to a human food or beverage preparer specifying how the user-defined food product or beverage should be prepared. System 10 allows the user to control the spatial distribution and geometric pattern of distribution of one or more ingredients and provides a visual representation of a user-defined food product before, during, and after it is prepared.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A remotely controlled system for the preparation of a user-defined food product or beverage comprising:
an input module on a remote device configured to input user-specified parameters associated with the preparation of the user-defined food product or beverage;
a user profile module on one or more servers configured to store one or more of the user-specified parameters, predetermined alerts, and nutritional information associated with the user-specified parameters and send one or more of the user-specified parameters, predetermined alerts and nutritional information for display on the input module;
a local controlling computer subsystem responsive to the input module on the remote device for translating the user-specified parameters from the input module into one or more commands; and
an automated food preparation subsystem responsive to the local controlling computer subsystem configured to prepare the user-defined food product or beverage based on the one or more commands and interactive instructions from a user.

2. The system of claim 1 in which the user-specified parameters include a parameter chosen from the group consisting of: ingredient identity, ingredient amount, ingredient spatial distribution, ingredient geometric pattern, cooking temperature, cooking time, physical translation of a cooking device, a sequence of combinations of ingredients, a sequence of cooking operation instructions, a sequence of preparation and cooking operations, instructions to a food or beverage preparer, a user-provided list of ingredients, and a user-provided recipe.

3. The system of claim 1 in which the input module displays a graphical user interface provided by the one or more servers.

4. The system of claim 3 in which the remote device is a device chosen from the group consisting of: a client computer, a personal digital assistant (PDA), a human input device (HID), a wireless telephone, a personal communicator, and an internet tablet.

5. The system of claim 1 in which the remote device is connected to the one or more servers by a communication channel chosen from the group consisting of: the internet, a wide area network (WAN), a local area network (LAN), and a wireless communications channel.

6. The system of claim 5 in which the one or more servers are connected to the local controlling computer subsystem by a communication channel chosen from the group consisting of: the internet, a wide area network (WAN), a local area network (LAN), a wireless communications channel, and a direct connection.

7. The system of claim 6 in which the local controlling computer is connected to the automated food preparation subsystem by a communication channel chosen from the group consisting of: the internet, a wide area network (WAN), a local area network (LAN), a wireless communications channel, and a direct connection.

8. The system of claim 1 in which the automated food preparation subsystem includes one or more food processors.

9. The system of claim 1 in which the input module is configured to interactively compute the cost related to the preparation of the user-defined food product or beverage.

10. The system of claim 9 further including a networked payment subsystem configured to receive payment for the user-defined food product or beverage.

11. The system of claim 1 in which the automated food preparation subsystem includes a video device for providing a visual representation of the user-defined food product or beverage before, during, and/or after the user-defined food product or beverage is prepared.

12. The system of claim 11 in which the graphical interface displays the appearance of the user-defined food product or beverage before, during and after the food product is prepared on the input module.

13. The system of claim 2 in which the user profile module is configured to retrieve nutritional information associated with each user-selected ingredient and/or each user-selected ingredient amount and/or each user-specified list of ingredients and/or each user-provided recipe from the one or more servers.

14. The system of claim 13 in which the one or more servers includes one or more servers chosen from the group consisting of: a remote server, a local sever, and a combination of one or more remote servers and one or more local servers.

15. The system of claim 1 in which the input module stores one or more user-specified templates.

16. The system of claim 15 in which the one or more user-specified templates define the ingredient spatial distribution and the ingredient geometric pattern of the user-defined product.

17. The system of claim 13 in which the predetermined alerts include an alert chosen from the group consisting of: any alert indicating a user provided nutritional limit may be exceeded, an alert indicating an undesirable user-defined food product or beverage will be prepared, an alert indicating an injurious user-defined food product or beverage will be prepared, and an alert indicating a physically impractical user-defined food product or beverages will be prepared.

18. The system of claim 17 in which the alert indicating an injurious user-defined food product or beverage will be prepared includes an indication the user is allergic to at least one ingredient in the user-defined food product or beverage.

19. The system of claim 1 in which the user-specified parameters are input by one or more users at one or more remote locations.

20. The system of claim 1 in which the user remotely controls the user-specified parameters to be used in the preparation of the user-defined food product or beverage by the automated food preparation subsystem.

21. The system of claim 1 in which the automated food preparation subsystem includes a human food or beverage preparer.

22. The system of claim 21 in which the user remotely controls the user-specified parameters to be used in the preparation of the user-defined food product by the human food or beverage preparer.

23. The system of claim 1 in which the automated food preparation subsystem is robotic.

24. The system of claim 1 in which the automated food preparation subsystem is teleoperated.

25. The system of claim 1 in which the automated food preparation subsystem is robotic and teleoperated.

26. The system of claim 1 in which the user-defined food product or beverage is a food product or beverage chosen from the group consisting of: a pizza, an ice cream sundae, a dessert, a meal eaten at a restaurant, take-out food, and a mixed beverage.

27. A remotely controlled system for the preparation of a user-defined food product or beverage comprising:
an input module on a remote device configured to receive user-specified parameters associated with the preparation of the user-defined food product or beverage;
a nutritional module configured to retrieve nutritional information from one or more servers of the user-specified parameters and compute and display the nutritional information to a user;
a local controlling computer subsystem responsive to the input module on the remote device for translating the user-specified parameters from the input module on the remote device into one or more commands; and
an automated food preparation subsystem responsive to the local controlling computer subsystem configured to prepare the user-defined food product or beverage based on the one or more commands and interactive instructions from a user.

28. A remotely controlled method for the preparation of a user-defined food product or beverage, the method comprising:
receiving user-specified parameters associated with the preparation of the user-defined food product or beverage on an input module;
storing one or more of the user-specified parameters, predetermined alerts, and nutritional information associated with the user-specified parameters on one or more servers and sending and displaying the user-specified parameters, predetermined alerts and nutritional information for display on the input module;
translating the user-specified parameters from the input module into one or more commands; and
controlling the preparation of the user-defined food product or beverage based on the one or more commands and interactive instructions from a user.
